(19) United States
(12) Patent Application Publication
(10) Pub. No.: US 2003/0223115 A1
(43) Pub. Date: Dec. 4, 2003

(54) Beam splitter device

(76) Inventor: Heinrich Spiecker, Bielefeld (DE)

Correspondence Address: JORDAN AND HAMBURG LLP, 122 EAST 42ND STREET, SUITE 4000, NEW YORK, NY, 10168, US

(21) Appl. No.: 10/442,402

(22) Filed: May 21, 2003

(30) Foreign Application Priority Data
May 29, 2002 (DE) 102 23 911.8-51

(51) Int. Cl. G02B 5/30; G02B 27/28

(52) U.S. Cl. 359/495

(57) ABSTRACT

The subject matter of the invention is a beam splitter device comprising at least two spaced apart highly reflective mirrors between the two of which a partially reflecting mirror is disposed, said partially reflecting mirror having a partial reflectivity coating and the coating being formed in such a manner that the reflection curve produced by the coating exceeds the reflection coefficient of 50% in the range of at least one wavelength.

### 1. FIELD OF THE INVENTION

The present invention relates to a beam splitter device comprising at least two spaced apart highly reflective mirrors between the two of which a partially reflecting mirror is disposed.

### 2. DESCRIPTION OF THE PRIOR ART

Light beams e.g., laser light beams of substantially the same intensity are intended to be produced, using these known beam splitter devices (DE 199 04 592 C2). If, accordingly, a plurality of beams of substantially the same intensity are focused onto a sample, a signal is obtained in the event of one or more photon excitations that is the same at any site of the sample which is impinged by a beam split.

More specifically, there is provided that, with this beam splitter device, the actual splitting process occurs at the partially reflecting mirror disposed between the highly reflective mirrors. One half of the beam is thereby transmitted and the other half reflected. The resulting two beam splits are then reflected back onto the beam splitter plate by means of mirrors, the beam splits which impinge for the second time on the partially reflecting or transflective mirror being again doubled in number but with an accordingly reduced intensity. Meaning, the power of each beam is divided by two at each splitting. Two beams with 1, 2, 4, 8, 16 and so on rays respectively can thus be produced, said rays being inclined to each other at an incremental angle if the highly reflective mirrors are tilted at the proper angle.

As already explained, the beams are divided by two at each splitting step, said splitting being associated with a decrease in the intensity after each splitting step. The important point is that the beam splits have the same intensity after each splitting step in order to obtain comparable results of measurement when the sample is irradiated by the corresponding beam splits of the beams. Accordingly, it is very disadvantageous when the various beam splits exhibit whatever small differences in intensity. Meaning, the production of a beam with rays of the same power which permit to eliminate all the artifacts in the measurement process is subject to the proviso that, by way of the partially reflective mirror, the intensity of the rays is always reduced by exactly 50 percent as they are divided by two i.e., that the reflection coefficient is indeed exactly 50 percent.

According to the state of the art (FIG. 1), the reflection curve produced by the coating of the partially reflecting mirror does actually not reach the reflection coefficient of 50% over a great wavelength range, but is rather above or below that coefficient. This means that the beam splitter unavoidably produces beam splits of different intensities which affects the quality of the results of measurement.

### BRIEF SUMMARY OF THE INVENTION

It is therefore the object of the present invention to provide a beam splitter device of the type mentioned herein above that permits to produce a plurality of beam splits of exactly the same intensity.

The solution to this object is achieved, in accordance with the invention, by configuring the coating in such a manner that the reflection curve produced by the coating exceeds the reflection coefficient of 50% in the range of at least one wavelength. The basic thought thereby is that it is not necessary to provide a reflection curve providing a reflection coefficient of exactly 50 percent over a wide wavelength range. It will suffice if the reflection curve has a reflection coefficient of exactly 50 percent at diverse wavelengths. Within the range of 700 to 1,100 nm, the reflection curve may for example show a reflection coefficient of exactly 50 percent on four locations. Meaning that a laser which impinges on the partially reflecting mirror with a light of exactly this wavelength produces beam splits that exhibit after each splitting step exactly 50% of the intensity the beam had prior to splitting. This signifies that the reflection curve is undulated if one assumes that, in a certain wavelength range, this curve crosses the line of the reflection coefficient of 50% at various points. The advantage of a thus formed coating, which is for example configured as a dielectric coating, is that fairly large process tolerances are possible in manufacturing such partially reflecting or transflective mirrors because the principle that the reflection curve reaches the reflection coefficient of 50% at various locations within one wavelength range, e.g., between 700 and 1,100 nm, in such a manner that it crosses the 50% line can be achieved without great expenditure. Tuning the laser to wavelengths with a reflection coefficient of exactly 50% is fairly easy.

According to a particularly advantageous feature of the invention, there is provided that, in the range between 700 nm and 1,100 nm, the gradient of the reflection curve, at the points where it crosses the line representing the reflection coefficient of 50%, is not less than 1×10⁻⁴/nm, advantageously not less than 4×10⁻⁴/nm. The steeper the reflection curve in the region of the points at which the line of the reflection coefficient of 50% is crossed, the more accurately can the position of the crossing point be kept in spite of manufacturing flaws. It is also advantageous if the reflection curve crosses the line representing the reflection coefficient of 50% at three sites at least. The reason therefore is that the operative range of the beam splitter increases as a function of the number of crossing points.

It is further advantageous if the partially reflecting mirror is spaced different distances from the highly reflective mirrors in order to produce a plurality of beam splits spaced different distances apart.

The invention will be explained in closer detail herein after with reference to the drawing.

### BRIEF DESCRIPTION OF THE SEVERAL VIEWS OF THE DRAWING

FIG. 1 schematically shows a reflection curve as it is typically chosen according to prior art with a coating of a partially reflecting mirror, with the reflection coefficient being plotted down the side of the diagram whereas the wavelength is plotted on the horizontal axis;

FIG. 2 is an illustration according to FIG. 1, the coating of the partially reflecting mirror being formed in such a manner that the reflection curve shows an undulating shape.

### DETAILED DESCRIPTION OF THE INVENTION

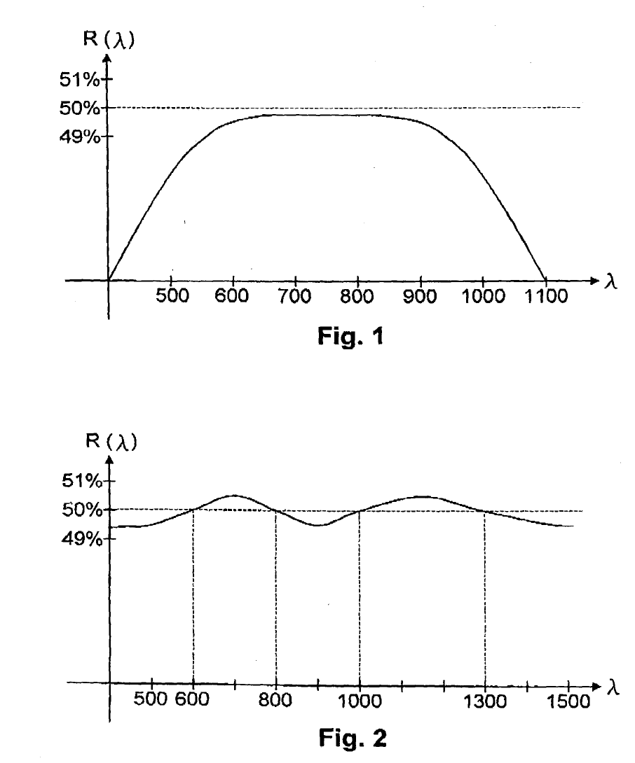

In the representation according to FIG. 1, which shows the reflection curve with a coating according to prior art, it can be immediately seen that, although the reflection curve almost reaches the 50% line over even a quite large wavelength range, it does not exactly meet the 50% line, due to manufacturing tolerances. This results in the intensity of the discrete beam splits being different at each beam splitting step. It is important that the flaw, which is fairly small with one splitting, becomes more important with each splitting step. Meaning that, if it comes to it, the results obtained by the measurement performed with the beam being split into many beam splits are useless.

This is totally different with a coating built up according to the teaching of the invention. From FIG. 2 it can be immediately seen that the reflection curve crosses the line of a reflection coefficient of 50% at different locations only, namely exactly in the range of 600, 800, 1,100 and 1,300 nm, and that the transflective mirror has a reflection coefficient of exactly 50% at these very locations. This means that at these selected wavelengths, any number of beam splits of identical intensity can be produced. The variations in the reflection coefficient as a result of manufacturing tolerances only cause the selected wavelengths at which the reflection coefficient is exactly 50% to shift. This does not affect the overall suitability of the splitter though.

I claim:

1. A beam splitter device comprising at least two spaced apart highly reflective mirrors between the two of which a partially reflecting mirror is disposed, said partially reflecting mirror having a partial reflectivity coating, characterized in that the coating is formed in such a manner that the reflection curve produced by the coating exceeds the reflection coefficient of 50% in the range of at least one wavelength.

2. The beam splitter device according to claim 1, characterized in that the coating is a dielectric coating.

3. The beam splitter device according to claim 1, characterized in that, in the range between 700 nm and 1,100 nm, the gradient of the reflection curve, at the points where it crosses the line representing the reflection coefficient of 50%, is not less than 1×10⁻⁴/nm, advantageously not less than 4×10⁻⁴/nm.

4. The beam splitter device according to claim 1, characterized in that, the reflection curve crosses the line representing the reflection coefficient of 50% at three sites at least.

5. The beam splitter device according to claim 1, characterized in that, the partially reflecting mirror is spaced different distances from the highly reflective mirrors.
